(19) United States
(12) Patent Application Publication
(10) Pub. No.: US 2010/0258604 A1
(43) Pub. Date: Oct. 14, 2010

(54) FRACTURE SEPARATION MODULE FOR A MACHINE TOOL, MACHINE TOOL WITH A FRACTURE SEPARATION MODULE, AND FRACTURE SEPARATION METHOD

(75) Inventors: Ralf Müllner, Ostfildern (DE); Werner Brendle, Rosenberg (DE)

Correspondence Address: WOLF GREENFIELD & SACKS, P.C., 600 ATLANTIC AVENUE, BOSTON, MA, 02210-2206, US

(73) Assignee: Alfing Kessler Sondermaschinen GmbH, Aalen (DE)

(21) Appl. No.: 12/666,479

(22) PCT Filed: Jun. 24, 2008
(86) PCT No.: PCT/EP2008/058023

§ 371 Date: Jun. 7, 2010

(30) Foreign Application Priority Data
Jun. 27, 2007 (DE) 10 2007 029 663.2

(51) Int. Cl. B26F 3/00; B23P 19/00

(52) U.S. Cl. 225/2; 225/103; 173/47

(57) ABSTRACT

Fracture separation module for insertion into a machine tool, comprising: A drive spindle (10) with a receiving section for clamping the module into a spindle of a machine tool, a fracturing part (20) for the fracture separation of a workpiece, a conversion unit (30) which is connected both to the drive spindle (10) and to the fracturing part (20) and converts a rotational movement of the drive spindle (10) into a linear movement of the fracturing part (20), which movement is suitable for fracturing the workpiece, and a method for the fracture separation of a workpiece, wherein the fracture separation step takes place by means of the fracture separation module of the present invention.

### TECHNICAL FIELD

The invention concerns a fracture separation module for a machine tool, a machine tool with a fracture separation module and further a method of fracture separation of a work piece.

### PRIOR ART

The fracture separation (fracture-splitting) of work pieces, also known as cracking, is for example utilized in the production of connecting rods or crank cases for internal combustion engines. At first, in one production step, two diametrally opposite notches (indents) are formed in the inner peripheral surface of a bearing portion, which notches define a fracture plane along which the workpiece may be separated in two parts.

In the prior art, fracture separation as such is effected in a special fracture separation station in which an expanding element such as an expanding mandrel or a pair of expansion jaws are introduced into the portion to be separated so that the workpiece is separated along the predetermined fracture plane by means of the applied expansion forces and the stress concentration at the notch vertex.

After the fracture separation process (cracking) and some intermediate processing steps both parts may again be joined. Due to the irregular and comparatively extensive fracture surface created in fracture separation, a defined joining of workpieces is facilitated, wherein the indentations of the fracture surfaces prevent a lateral displacement of the workpiece parts.

In the state of the art, fracture separation is performed by special machinery. The workpiece has to be conveyed from a device which forms the notches defining the fracture plane, for example a broaching tool or a laser, to the fracture separation device. Such a method is, for example, disclosed in WO 2004/058446 A1. Here, a connecting rod is conveyed from a station for forming openings (bearing portions) and notches toward the station for fracture separation.

A device for fracture-splitting workpieces comprising a fracture separation station is disclosed in WO 03/011505 A2. Here, the processing station is arranged inside of a work table configured as circular table, and further processing stations are arranged in the outer peripheral area of the circular table.

In the state of the art, fracture separation by custom-made special machines renders inflexible the production of workpieces passing through the processing step of fracture separation. This is because fracture separation is tied to the device intended for fracture separation. Hitherto, fracture separation is therefore economically viable only for workpieces produced in large quantities. Up to now, the technological conditions for performing fracture separation on tooling suitable for low quantities were not present.

WO 01/70440 A1 discloses a method for fracture-splitting a connecting rod, wherein prior to splitting the connecting rod is stuck onto a mandrel split in half and the bearing eye is pretensioned. By introducing a wedge between the two mandrel halves, the positionally fixed bearing shell is separated by the associated mandrel half from the bearing shell fixed to the other mandrel half through substantially simultaneous braking of both sides.

### SUMMARY OF THE INVENTION

It is, thus, an object of the present invention to develop a fracture separation module for a machine tool, a machine tool with a fracture separation module and a fracture separation method in order to allow an economically advantageous use of fracture separation also for quantities requiring flexible tooling.

On the one hand, the object is achieved by means of a device according to claims 1 and 15 as well as a method according to claim 16. Further advantageous embodiments are defined in the dependent claims.

The invention provides a versatile standardised module for fracture separation of workpieces, not only of workpieces for internal combustion engines, but also for workpieces produced in small batches, and which may be employed in conjunction with machine tools and especially in machining centers with standardized interfaces. A flexible production is also possible with the inventive fracture separation method, which preferably utilizes the above module. The possibility of performing cracking in machine tools, in particular machining centres, allows for an economically advantageous production also in small batch series.

To that end, the fracture separation module of the present invention comprises, for a machine tool, a drive shaft for inserting the module into a mandrel (arbor) of a machine tool, a fracture part for fracture-splitting a workpiece and a conversion unit connected both with the drive shaft and with the fracture part and converting a rotary motion of the drive shaft into a linear motion of the fracture part suitable for splitting the workpiece.

According to the invention, the retainer portion of the module of the present invention is inserted into a machine tool, for example a machining center, via a mandrel which is a component part of the machine tool and represents an interface. The rotary motion of the mandrel is transferred to the drive shaft and may, by means of a conversion unit, be directly converted into a linear motion suitable for fracture-splitting by means of the fracture part. Preferably, the rotary motion of the drive shaft is converted simultaneously, that is without potential delay introduced by storing the energy applied by the mandrel, into a linear motion of the fracture part by bracing the fracture part, preferably at a fixed mandrel flange. In this case, the fracture separation module may, on the one hand, have a simple construction while on the other hand a force transmission may be desired in order to achieve the necessary advance force required for fracture-splitting the workpiece. In a direct conversion of the rotary motion into a linear motion, a tension slowly builds up in the workpiece, for example in the con-rod bearing portion to be fractured. By controlling the rotation speed it is advantageously possible to configure the linear motion in a non-uniform manner and thus to control the force path (force progression) independently of the geometry of the fracture part, or also to adapt them to different geometries of the fracture part.

If such a continuous load is not desired, the conversion unit may be configured so that a predetermined energy of the rotating drive shaft is stored at first, which at later time is converted instantaneously into a motion of the fracture part. As an alternative to the hitherto described conversion of the rotary motion of the drive shaft into a linear motion of the fracture part, it is possible within the framework of the present invention to convert the rotary motion into an expanding motion or another motion suitable for fracture-splitting. For example, the embodiment of fracture-splitting may depend on the geometrical characteristics of the workpiece to be fractured.

A fracture separation module of the above embodiment may both be manufactured economically and be versatile and flexible. A stationary link of the cracking process to a special machine is, thus, no longer necessary, which in particular allows for an economical and efficient production of connecting rods and other workpieces in which a fracture process is required.

Preferably, the fracture separation module comprises a housing, wherein the drive shaft is rotatable with respect to the housing. Further, the conversion unit preferably comprises a torque support bracing the housing against rotation of the drive shaft. On the one hand, a suitable housing facilitates transport, insertion and removal of the module, and on the other hand the housing, together with a torque support, may serve the functional aspect of converting the rotary motion into a linear motion.

Preferably, the conversion unit comprises a drive unit for receiving and storing energy provided by the machine tool via the mandrel (arbor), and a latch device for setting free the stored energy. It may be desired that the fracture range of the fracture separation module is variably adjustable. While in the splitting of passenger car con-rods about 12 to 17 kN are necessary, about 52 to 95 kN are required in the fracture of con-rods for lorries. The conversion unit of the present invention may provide such a variable fracture range by means of a suitable force transmission or storage.

To that end, in a preferred embodiment, the drive unit further comprises a piston displaceable in an axial direction of the drive shaft and coupled to the fracture part, one or more springs against which the piston may be tensioned by displacing it along the axial direction of the drive shaft, and a nut riding on the drive shaft, wherein during tensioning at least a part of the nut is connected to at least a part of the piston so that the nut moving along the drive shaft tensions the piston against the spring/springs. Several springs may be symmetrically arranged around the drive shaft. A spring typically employed in the present invention has an excursion of between about 30 and about 40 mm, preferably of about 35 mm, a nominal force of between about 7.000 and about 7.500 N, preferably of about 7.250 N, and a length of between about 125 and about 130 mm, preferably of about 127 mm. Preferably, several springs are arranged in the radial and circumferential directions around the drive shaft. If six springs of this type are symmetrically arranged in the radial and circumferential directions around the drive shaft, a total nominal force of about 43.5 kN may be generated. According to the field of application and depending on the required advance forces both the parameters of the springs and their number may be adjusted as desired.

Preferably, the springs are either fluid pressure springs, mechanical or magnetic springs. Mechanical springs are cheap standard components available in many different configurations and are, thus, particularly suitable for use in the present module. However, it may be desirable to employ energy storage having different characteristics, such as a different force-displacement characteristic. For example, in a magnetic spring, the force path may be constant across the entire working stroke. By choosing the type of energy storage force control, both of the tensioning process and of the energy release, may be influenced in a targeted manner.

Preferably, the latch device is configured so that it releases the tensioned piston via an outer signal, for example a hydraulic, electromagnetic or mechanical signal. After the piston has been tensioned, the actuating unit keeps the piston in the tensioned position, for example by engaging pins with recesses in the piston provided for them. In response to an outer signal, the latch device releases the fastening so that potential energy stored in the spring is converted into kinetic energy of the piston. Here, it is not necessary that the fastening acts in a mechanical manner. As further possibility, an electromagnetically acting latch device shall be mentioned, which holds the piston in the tensioned position by exploiting electromagnetic forces.

Preferably, the fracture separation module is configured so that it is inserted via a standard interface into a machine tool in a machining center. Standard interfaces such as a hollow taper shank receiver according to DIN 69893 or steep tapers according to DIN 69871 are particularly preferred. Using the fracture separation module in a machining center is economically advantageous because no special machine has to be developed and used. In particular, by using a fracture separation module of the present invention a stationary link to special machines is avoided. Machining centers provide standardized interfaces and are, thus, particularly suitable with regard to a modularisation of fracture separation.

Preferably, the fracture part is wedge-shaped. Such a component may be easily and cheaply manufactured. Apart from the forceful, linear insertion of the fracture part into a stationary bearing portion, for example, or into a fracture mandrel introduced in the bearing portion, no additional mechanisms are further necessary for fracture separation.

Further, the object of the present invention is achieved by a method of fracture separation of a workpiece, in which the step of fracture separation is effected by means of the fracture separation module of the present invention.

Preferably, the cracking process is controlled and monitored by a CNC-control. Here, a continuous targeted power control is possible, whereby a comfortable optimisation of the fracture behaviour can be performed. The force progression of the fracture process is controllable without problems. For example, in the case of a simultaneous force transmission as described above, a force may at first be slowly applied in order to install the fracture mandrel and, subsequently, the force may be abruptly increased to perform the fracture separation. In particular, the current draw of the fracture process can be monitored in connection with a tool monitoring system or directly to the CNC-control. An additional force sensor is not necessary then.

Preferably, the method of fracture separation of a workpiece further comprises tensioning the workpiece, scoring the surface of the region or regions to be fracture-splitted, area-by-area fracture-splitting the workpiece and releasing and/or remounting the workpiece. Further, the steps of scoring and fracture-splitting are preferably effected in a mount. After forming the notches, the workpiece no longer has to be conveyed from a laser device, for example, toward a fracture separation station. This noticeably simplifies the procedure, reduces initial outlays for the device, because only a single processing station instead of two separate stations—the laser station and the fracture separation station—needs to be provided, and increases processing precision.

Preferably, the method of fracture separation of a workpiece comprises fixed clamping at one side and movable clamping at another side. This ensures that upon cracking the cracked-off part can move in a limited and controlled manner during fracture separation. Preferably, the method of fracture separation of a workpiece further comprises the pressing together of the fracture separated areas, preferably after cleaning the fracture separated surfaces and/or by means of the movable clamping device. Preferably, the methods of fracture separation of a workpiece further comprises a smoothing step (honing or the like) of the fracture separated component, preferably in the same mount.

### BRIEF DESCRIPTION OF DRAWINGS

In the enclosed drawings,

FIG. 1 shows a side view of a fracture separation module of a first embodiment of the present invention;

FIG. 2 shows a sectional view of a fracture separation module of FIG. 1, in which the components of the conversion unit are exposed;

FIG. 3 shows a sectional view of a part of the conversion unit;

FIG. 4 shows a schematic view of a machining center utilizing the fracture separation module of the present invention;

FIGS. 5a to 5c show sectional views of the fracture separation module of FIG. 1 in different operating states;

FIG. 6 shows a side view of a fracture separation module according to a second embodiment of the present invention.

### PREFERRED EMBODIMENTS OF THE INVENTION

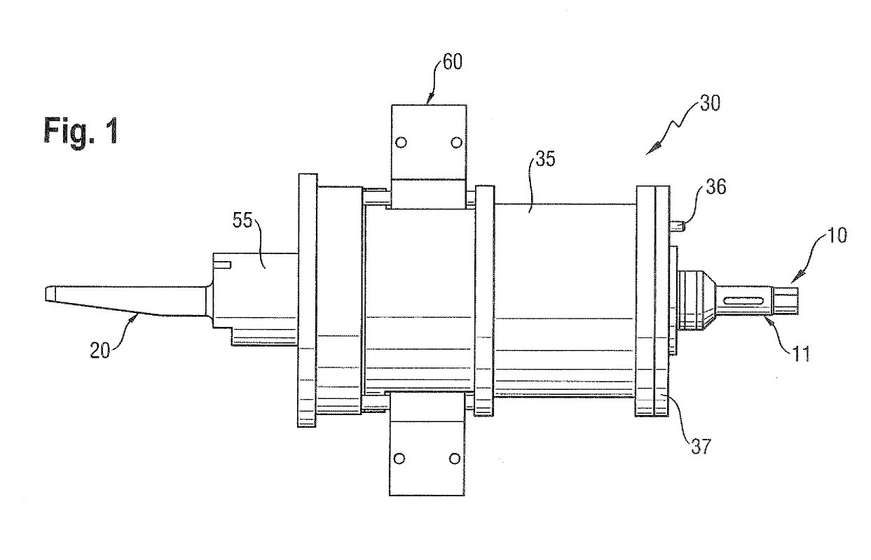

FIG. 1 is a side view of a fracture separation module. Reference numeral 10 indicates a drive shaft protruding from a base surface of the housing 35 of the conversion unit 30, a part of which drive shaft is visible in FIG. 1 and forms a receiving portion 11 through which the module may be mounted in a machine tool. At the opposite side of the conversion unit 30 there is arranged a fracture part 20 used for fracture-splitting of a bearing portion of a connecting rod. The fracture part 20 is wedge-shaped, and connected to the front end of a piston fixture 55 to be described further below in greater detail. Further, FIG. 1 shows a part of the latch device 60 and a part of the torque support 36, the structure and functions of which are also described further below in greater detail.

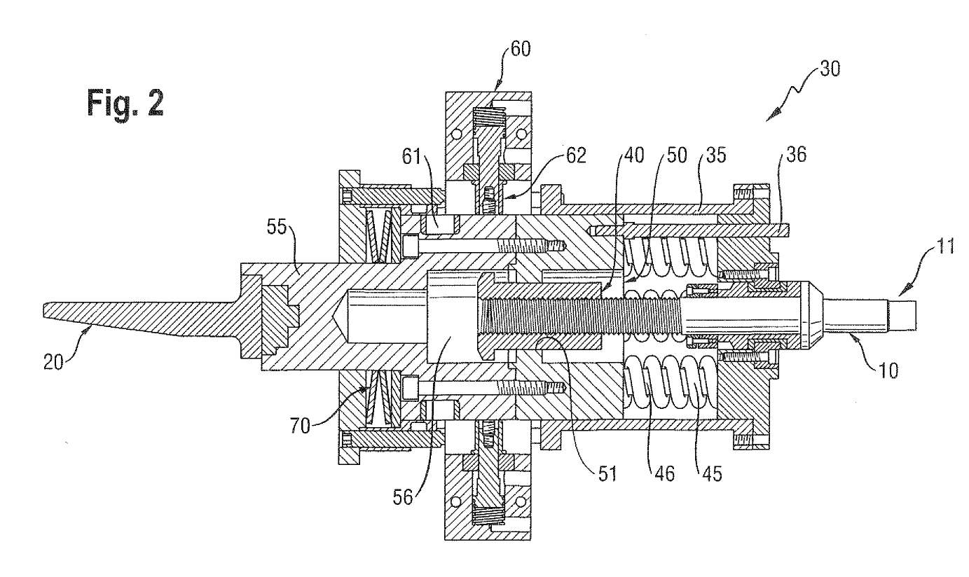

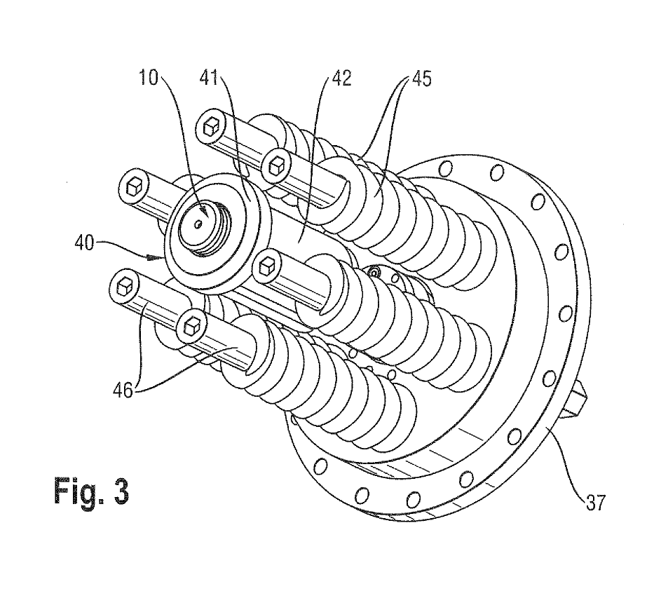

FIG. 2 shows a sectional view of the fracture separation module, and FIG. 3 is a perspective view of the region of the conversion unit 30 on the side of the drive shaft.

As can be seen from FIG. 3, a housing lid 37 is provided, which closes the cylindrical housing 35 of the conversion unit 30 at the side of the drive shaft. Guide pins 36 are attached to the housing lid 37, with compression springs 45 being slipped over them. As will yet be explained in more detail, a piston 50 is tensioned via these compression springs 45. The guide pins 45, together with compression springs 45 are arranged in parallel to and symmetrically around the drive shaft 10.

It is of course possible to use only one spring, which will then be preferably arranged centrally. Although in the embodiment coil springs made of steel are slipped over guide pins 46, other energy storages may be used, too. For example, in the recent years fibre-reinforced composites such as special fibre-glass reinforced plastics are increasingly used in the construction of springs. Further, apart from mechanical springs, fluid pressure springs or magnetic springs may be used. By choosing the type of energy storage, targeted influence can be exerted on the force control, both of the tensioning operation and of the release.

A thread is formed on the drive shaft 10 at the end opposite to the receiving area of the drive shaft. A nut 40 rides on the thread. The nut 40 has a cylindrical shape and, apart from a shank 42, further has a protruding, equally cylindrical portion 41 on the side of the fracture part.

A piston 50 is provided in the housing 35, see FIG. 2, which piston is displaceable in an axial direction. Apart from openings for receiving the guide pins 46, the piston 50 has a further through-opening 51 provided along the axial axis of symmetry of the piston 50 and dimensioned so as to be able to receive the shank 42 of the nut 40 so that the nut 40 and the piston 50 may be displaced in parallel against each other. The diameter of the protruding portion 42 is larger than the diameter of the opening 52. Therefore, the displacability between nut 40 and piston 50 is limited to one side. Further, the piston 50 has an opening for receiving a torque support 46. The torque support is connected to the housing 35 via a housing lid 47 and, opposite to the housing 35, projects outwardly.

A piston attachment 55, at an end of which the fracture part 20 is attached, is fixedly connected to the piston 50 at the other side. The piston attachment 55 includes a recess 56 at the side of the drive shaft. This recess 56 is provided in two parts, wherein the front recess portion (on the side of the fracture part) has a smaller diameter with respect to the rear recess portion (on the side of the drive shaft). The front recess portion is dimensioned so as to be capable of receiving a part of the drive shaft 10. The rear recess portion is provided so as to be capable of receiving the projecting portion 51 of nut 40 and a part of shank 42 of nut 40.

At the periphery of the housing 35, a latch device 60 is provided, which locks the piston 50 in a tensioned condition and releases the lock due to an outer signal so that the potential energy stored in the compression springs 45 may promptly be released and transferred to the piston 50 and, thus, to the fracture part 20 via the piston attachment. In the present embodiment, the latch device 60 comprises recesses 61 or a groove 61 which is formed in the peripheral surface of the piston attachment. In a locked state the pins 62 are engaged with groove 61. This engagement is released in response to an outer signal.

Finally, the housing 35 may include an attenuator 70, see FIG. 3, which decelerates the impact of the piston 50 via the attachments in order not to damage the housing 35.

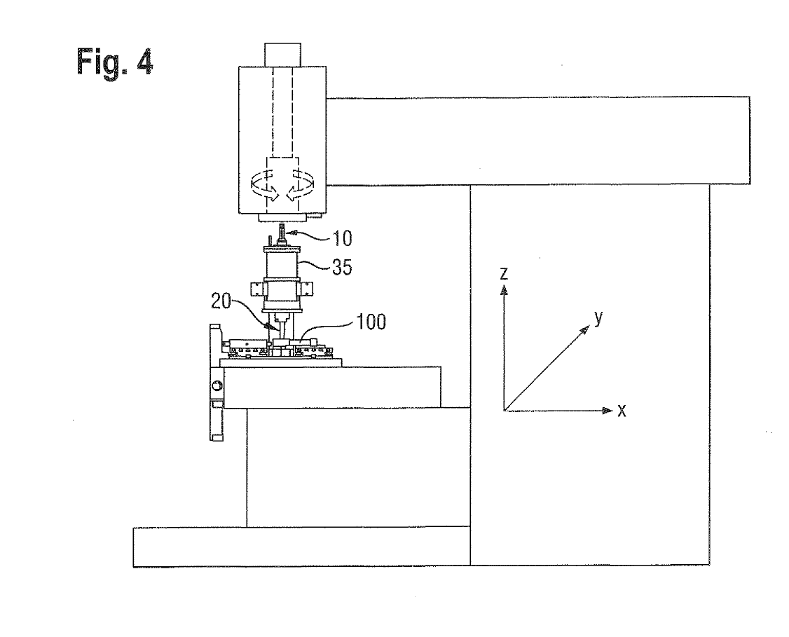

In the following the operation and application of the fracture separation module in a machining center (MC) will be described. To that end, as shown in FIG. 4, the fracture separation module is mounted into the machining center via drive shaft 10, wherein the torque support is inserted into an opening provided for it in the MC. Utilization in other machine tools, for example, multi-axis cutters, is of course possible.

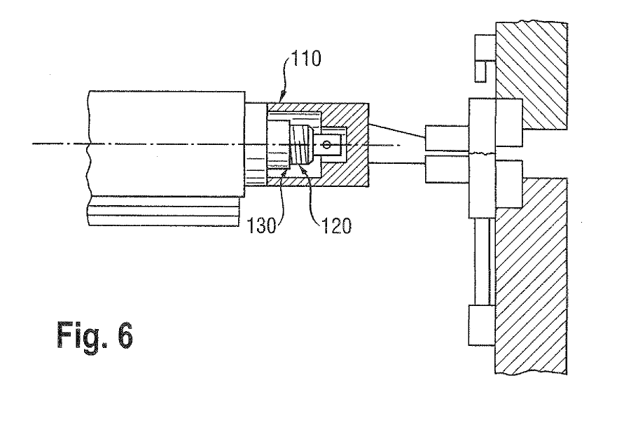

Next, a con-rod 100 is clamped onto the table of the MC by means of a standard device so that the extension of the fracture part 20 in the Z-direction (axial direction) intersects the sectional area of the bearing portion of the con-rod. In order to achieve defined fracture result and not to damage the bearing portion apart from the intentional fracture, a fracture mandrel may be introduced into the bearing portion (see FIG. 6). Here, a tensioning device is preferably employed, a part of which fixes the shank and the piston boss (piston pin eye) and a further part of which movably holds the bearing cap to be separated and which presses the latter after fracture separation and, if need be, shaking as is known in the state of the art.

The con-rod has already been prepared conventionally by means of two notches 18 diametrically opposite to each other, for example.

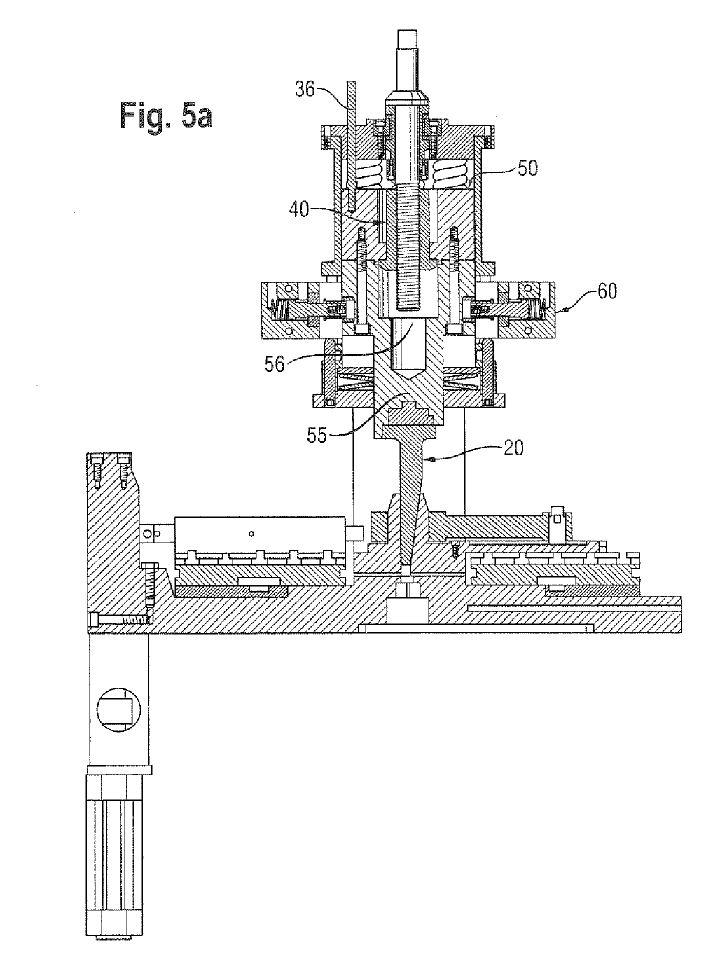

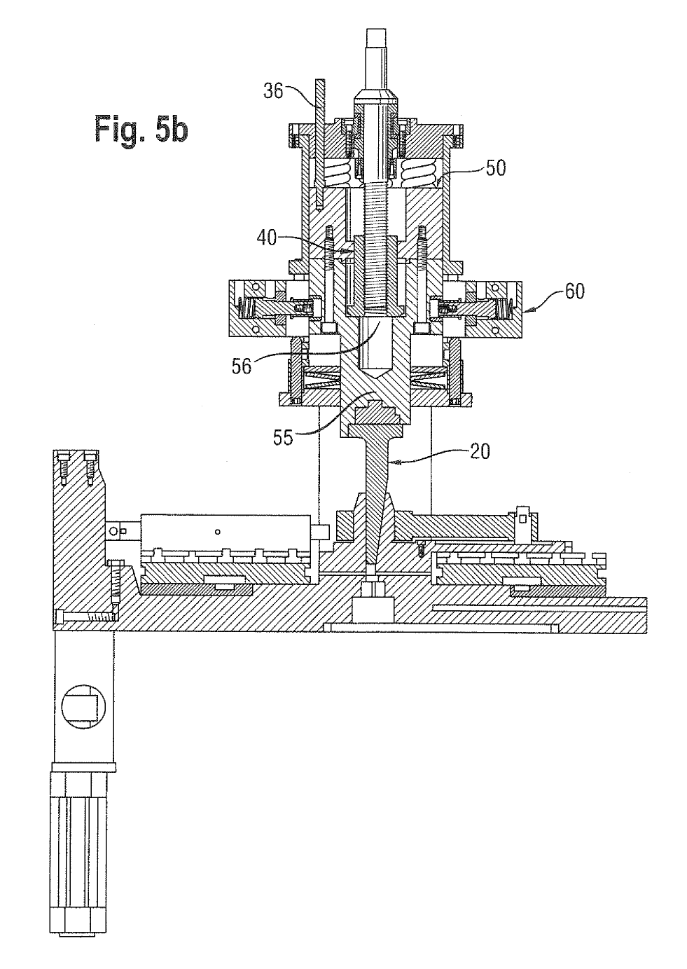

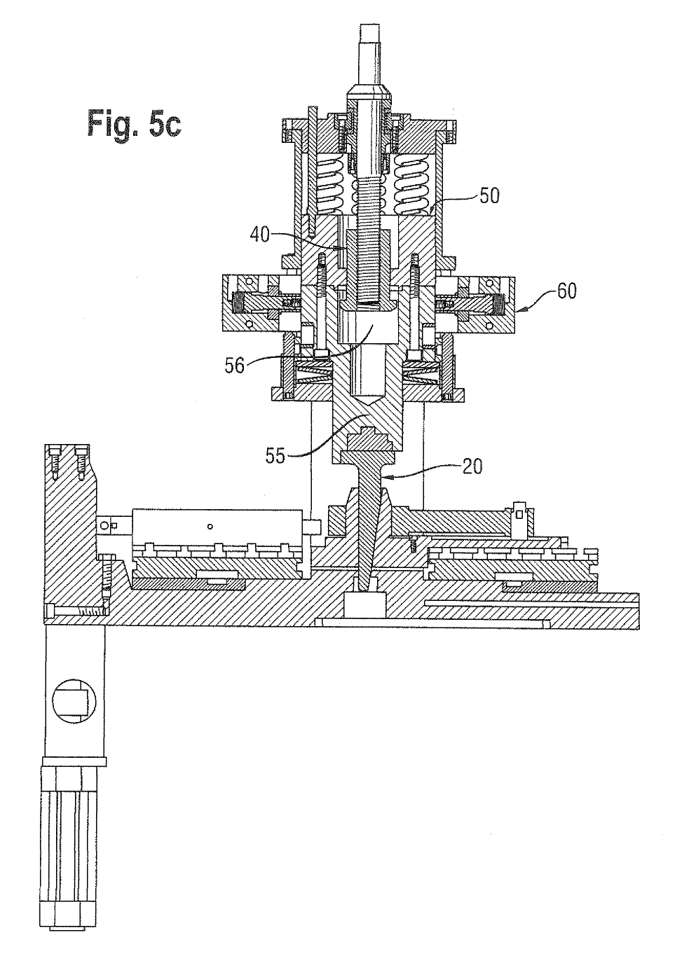

FIGS. 5a to 5c show various states the fracture preparation module may assume during use. FIG. 5a shows the tensioned piston 50. Here, the projecting portion 41 of the nut 40 comes into contact with the surface of the piston 50 on the side of the fracture part. The rotation of the drive shaft 10 is converted via the thread of the drive shaft 10 into a linear motion of the nut 40 in axial direction. The latter moves together with the piston 50, piston attachment 55 and fracture part 20 upwards in the Z-direction, wherein a force has to be applied against springs 45. Apart of the expanded energy is thereby stored in the springs 54 as potential energy.

In a tensioned state, the piston attachment 54 is locked by means of a latch device 60 and the direction of rotation of the drive shaft 10 is inverted so that the nut 40 is reset as shown in FIG. 5b, wherein it is received by the front recess portion of the piston attachment 55. In doing so, the latch device 60 keeps the piston attachment 55 and, thus, the piston 50 and the fracture part 20 in a tensioned state. Upon an outer signal, for example, a hydraulic or electromagnetic signal, the lock is released so that the potential energy stored in the springs 45 is converted into a linear motion of the piston 50, the piston attachment 55 and the fracture part 20. The release of energy occurs abruptly (instantaneously) so that the fracture part 20 is thrust into the bearing portion in such manner that the bearing portion is separated along the predetermined fracture plane. This operative state of the module is shown in FIG. 5c. By retensioning the springs 45, the above operation may be repeated.

In the present embodiment, a mechanical latch device is utilized. In order to reduce mechanical strength and, thus, wear at the parts involved in the locking, an electromagnetically acting latch device may be utilized as further possibility. To that end, electromagnets may be provided in or on the housing 35 and on the piston 50, for example. In a tensioned state, these magnets are switched on so that the piston is held in its tensioned position by an attracting or repulsive magnetic force. By switching the magnetic fields off, the lock is released so that the potential energy stored in the springs 45 is converted into a linear motion of the piston 50, the piston attachment 55 and the fracture part 20.

FIG. 6 depicts a further embodiment of the present invention. In this embodiment, the forward motion of the fracture part 20 is not effected due to a sudden release of tensioned springs 35, but the force necessary for splitting is applied via a support 110 of the fracture part 20, which support is part of the conversion unit 30, at the fixed drive shaft flange of the MC, simultaneously via a machine axis.

In the present embodiment, the fracture part 20 is connected to a threaded shaft 120 and is displaceably arranged in the fracture part support 110. The threaded shaft 120 is in threaded connection with a receiving portion 130 which serves as interface to the arbour of the MC. The rotary motion of the drive shaft 10 is converted into a linear motion of the fracture part 20, wherein the forward movement of the fracture part 20 is exploited to break the bearing portion of the con-rod at the prepared locations via a fracture mandrel.

1. Fracture separation module for a machine tool, comprising:
(a) a drive shaft having a receiving portion for inserting the module into an arbor of a machine tool;
(b) a fracture part for fracture-splitting a workpiece;
(c) a conversion unit which is connected both to the drive shaft and to the fracture part and which converts a rotary motion of the drive shaft into a linear motion of the fracture part suitable for fracturing the work piece.

2. Fracture separation module according to claim 1, wherein the fracture separation module further comprises a housing, wherein the drive shaft is rotatable with respect to the housing.

3. Fracture separation module according to claim 2, wherein the conversion unit includes a torque support supporting the housing against the rotation of the drive shaft.

4. Fracture separation module according to claim 1, wherein the rotary motion of the drive shaft is converted, under support of the fracture part, simultaneously into a linear motion of the fracture part.

5. Fracture separation module according to claim 1, wherein the conversion unit comprises a drive unit for receiving and storing the energy provided by the machine tool via the arbor, and a latch device for releasing the stored energy.

6. Fracture separation module according to claim 5, wherein the drive unit further comprises:
(c1) a piston displaceable in an axial direction of the drive shaft and coupled with the fracture part;
(c2) one or more springs against which the piston can be tensioned by moving it along the axial direction of the drive shaft; and
(c3) a nut riding on the drive shaft, wherein during tensioning at least one part of the nut is connected to at least a part of the piston in such manner, that the nut moving along the drive shaft tensions the piston against one or more of the springs.

7. Fracture separation module according to claim 6, wherein the latch device releases the tensioned piston, whereby the potential energy stored in the springs is converted into kinetic energy of the piston.

8. Fracture separation module according to claim 6, wherein the latch device is controlled by an external hydraulic, electromagnetic or mechanical signal.

9. Fracture separation module according to claim 6, wherein the springs have a nominal force of about 7.250 N, a length of about 127 mm and a stroke of about 35 mm.

10. Fracture separation module according to claim 6, wherein several springs are symmetrically arranged around the drive shaft in a radial and circumferential direction.

11. Fracture separation module according to claim 6, wherein the spring or the springs is/are either fluid pressure springs, mechanical or magnetic springs.

12. Fracture separation module according to claim 1, wherein it is to be inserted into a machine tool via a standard interface.

13. Fracture separation module according to claim 12, wherein the standard interface is a hollow shaft taper adapter according to DIN 69893 or a steep angle taper according to DIN 69871.

14. Fracture separation module according to claim 1, wherein the fracture part is wedge-shaped.

15. Machine tool having a fracture module according to claim 1.

16. Method for fracture separation of a workpiece, wherein the step of fracture-splitting is effected by the cracking module according to claim 1.

17. Method for fracture separation of a workpiece according to claim 16, further comprising the following steps:
tensioning the workpiece;
scoring the surface of the region or regions to be fracture-separated;
fracture-splitting the workpiece area-by-area; and
releasing and/or remounting the workpiece.

18. Method according to claim 16, wherein the steps of scoring and fracture-splitting are effected in one mount.

19. Method for fracture separation of a workpiece according to claim 16, wherein the fracture separation is controlled and monitored by a CNC-control.

20. Method for fracture separation of a workpiece according to claim 16, wherein the step of fracture-splitting comprises fixedly mounting the workpiece at one side and movably mounting it at another side.

21. Method for fracture separation of a workpiece according to claim 16, further comprising the pressing-together of the fracture-separated regions, preferably after cleaning the fracture-separated surfaces.

22. Method for fracture separation of a workpiece according to claim 21, further comprising surface finishing the fracture separated component, preferably in the same mount.
